(19) United States
(12) Patent Application Publication
(10) Pub. No.: US 2013/0285488 A1
(43) Pub. Date: Oct. 31, 2013

(54) COIL BLOCK, COIL BLOCK ASSEMBLY, AND ELECTRICAL MACHINE CONTAINING SAME

(71) Applicants: Evgeny Victorovich Kazmin, Moscow (RU); Mikhail Avramovich Avanesov, Moscow (RU); Gary Randall Barnes, Delanson, NY (US); Yury Danilovich Vinitzky, Moscow (RU); Natalja Stanislavovna Voiteko, Moscow (RU)

(72) Inventors: Evgeny Victorovich Kazmin, Moscow (RU); Mikhail Avramovich Avanesov, Moscow (RU); Gary Randall Barnes, Delanson, NY (US); Yury Danilovich Vinitzky, Moscow (RU); Natalja Stanislavovna Voiteko, Moscow (RU)

(73) Assignee: GENERAL ELECTRIC COMPANY, Schenectady, NY (US)

(21) Appl. No.: 13/823,410

(22) PCT Filed: Dec. 30, 2010
(86) PCT No.: PCT/RU2010/000806

§ 371 Date: Mar. 14, 2013

(51) Int. Cl. H02K 3/24

(52) U.S. Cl. CPC H02K 3/24
USPC 310/65

(57) ABSTRACT

Embodiments of the invention relate generally to electrical machines and, more particularly, to electrical machines containing a coil block assembly for cooling conductive coils. In one embodiment, the invention provides an electrical machine comprising: at least one tooth coil including: a stator tooth; and at least one conductive coil wound around the stator tooth, forming a plurality of coil turns; a coil block assembly between a first turn and a second turn of the plurality of coil turns, the coil block assembly including: at least two coil blocks, each coil block including a body and a face having at least one recess into the body, wherein the coil blocks are oriented with faces opposed, such that at least one cooling channel is formed by the at least one recess of each coil block.

### BACKGROUND OF THE INVENTION

Many electrical machines, such as wind turbine generators, traction motors, switched-reluctance motors, servo motors, stepper motors, and linear motors include armature or field windings comprising concentrated coils wound around a stator tooth. Such a tooth and its coils are commonly referred to as a tooth coil. Often, the coil arms (coil parts laying in the slot part of a machine) of such tooth coils have a relatively large width and experience an attendant temperature increase during operation. Indirect cooling of such tooth coils using conventional methods is difficult due to the concentration of the coil windings and the extent of temperature increase often experienced.

### BRIEF DESCRIPTION OF THE INVENTION

Embodiments of the invention relate generally to electrical machines and, more particularly, to electrical machines containing a coil block assembly for cooling conductive coils.

In one embodiment, the invention provides an electrical machine comprising: at least one tooth coil including: a stator tooth; and at least one conductive coil wound around the stator tooth, forming a plurality of coil turns; a coil block assembly between a first turn and a second turn of the plurality of coil turns, the coil block assembly including: at least two coil blocks, each coil block including a body and a face having at least one recess into the body, wherein the coil blocks are oriented with faces opposed, such that at least one cooling channel is formed by the at least one recess of each coil block.

In another embodiment, the invention provides an electrical machine comprising: a plurality of tooth coils, each tooth coil including: a stator tooth; and at least one conductive coil wound around the stator tooth, forming a plurality of coil turns; and a coil block assembly between an outer turn of the plurality of coil turns of a first tooth coil and an outer turn of the plurality of coil turns of a second tooth coil, the coil block assembly including a plurality of coil blocks, at least two coil blocks each including: a body; and a first face having at least one recess into the body, wherein the at least two coil blocks are oriented with first faces opposed to form at least one cooling channel including the at least one recess of each of at least two coil blocks.

In yet another embodiment, the invention provides a coil block comprising: a body including a proximal end having a first thickness and a distal end having a second thickness less than the first thickness; a first face having at least one recess into the body; a first surface substantially perpendicular to the first face; and a second surface angled with respect to the first surface and the first face, whereby a pair of coil blocks oriented with first faces thereof opposed has a substantially trapezoidal shape in cross-section and form at least one cooling channel comprised of the at least one recess of each of the pair of coil blocks.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a perspective view of a coil block according to an embodiment of the invention.

FIGS. 2-5 show side views and cross-sectional views of coil block assemblies according to embodiments of the invention.

FIGS. 6-9 show top and side cross-sectional views of tooth coils according to embodiments of the invention.

FIG. 10 shows a perspective view of a coil block according to an embodiment of the invention.

FIG. 11 shows a top cross-sectional view of a coil block assembly according to an embodiment of the invention.

FIG. 12 shows a top view of a tooth coil and coil block assemblies according to an embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

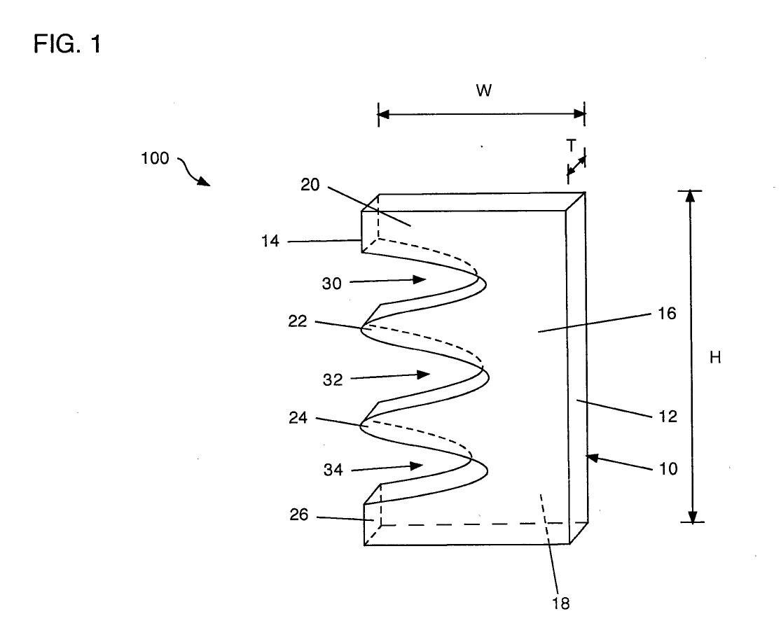

Turning now to the drawings, FIG. 1 shows a perspective view of a coil block 100 according to an embodiment of the invention. Coil block 100 includes a body 10 having a height H, thickness T, and width W, a first face 14, a second face 12, a first surface 16, and a second surface 18. In the embodiment shown in FIG. 1, first face 14 and second face 12 are substantially parallel to each other and substantially perpendicular to each of first surface 16 and second surface 18, such that body 10 has a substantially rectangular shape in cross section.

First face 14 includes a plurality of recesses 30, 32, 34 extending from first surface 16 to second surface 18 and extending into body 10. Portions of body 10 adjacent recesses 30, 32, 34 form islands 20, 22, 24, 26 extending substantially to an edge of, and therefore continuing to define, first face 14. As will be described in greater detail below, in some embodiments of the invention, thickness T is less than width W. In other embodiments of the invention, thickness T varies along height H.

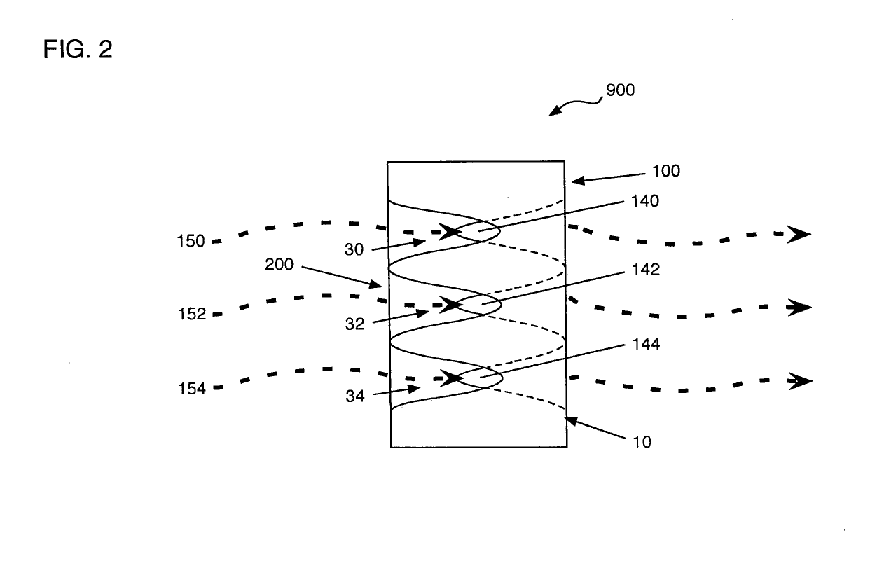

FIG. 2 shows a side view of a coil block assembly 900 comprising a pair of coil blocks 100, 200. Coil block 100 is stacked beside and oriented opposite to coil block 200, i.e., with recesses open to opposite directions. In such an arrangement, portions of recesses 30, 32, 34 in coil block 100 extending furthest into body 10 expose similar portions of the recesses of coil block 200, thereby forming cooling channels 140, 142, 144, through which airflow 150, 152, 154 may pass.

In the embodiments shown in FIGS. 1 and 2, recesses 30, 32, 34 and islands 22, 24 have a substantially sinusoidal shape. Other shapes may be used, of course, including a rectangular, ovoid, semicircular, etc. The shape or shapes employed will depend, for example, on the size of coil blocks 100, 200 and the desired size and/or shape of cooling channels 140, 142, 144. Similarly, while each of coil blocks 100, 200 are shown in FIG. 2 as having three recesses (30, 32, 34 in coil block 100), this is not essential. The number of recesses employed will depend, for example, on the size of the coil block and the desired amount of airflow through the coil block assembly. In addition, while each of the recesses 30, 32, 34 is shown as extending into body 10 in a direction substantially parallel to width W (i.e., substantially normal to thickness T and height H), this also is not essential. In some embodiments of the invention, recesses may extend into body 10 at an angle relative to width W, thickness T, and/or height H.

Similarly, while the coil block assemblies according to various embodiments of the invention are shown and described as including two coil blocks, this is not essential. For example, more than two coil blocks could be stacked as shown herein to form thicker coil block assemblies with deeper cooling channels. Merely for the sake of simplicity and ease of explanation, coil block assemblies according to embodiments of the invention are shown and described as including two coil blocks. Similarly, coil block assemblies according to embodiments of the invention may be milled or otherwise formed from a single block of material. In such embodiments, “coil blocks” refer to the portions of the block resembling distinct units or pieces, as would be understood by one skilled in the art.

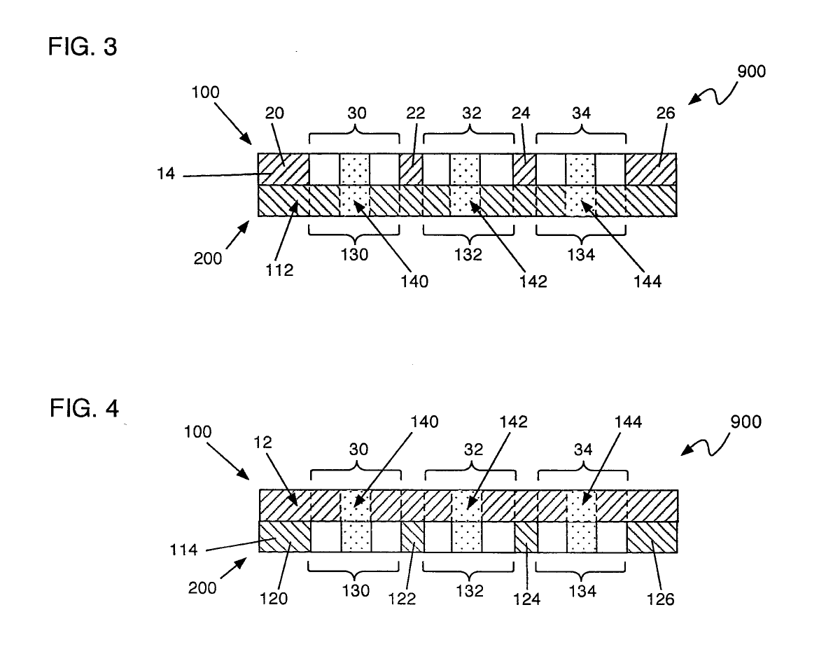

FIGS. 3 and 4 show side views of coil block assembly 900 along first face 14 of coil block 100 and second face 112 of coil block 200, respectively. In FIG. 3, it can be seen that cooling channels 140, 142, 144 are formed by the central portions of recesses 30, 32, 34 of coil block 100 and recesses 130, 132, 134 (shown in phantom) of coil block 200. FIG. 4 shows coil block assembly 900 along first face 114 of coil block 200, such that recesses 30, 32, 34 of coil block 100 are shown in phantom, as they would be obscured by second face 12 thereof.

Materials suitable for use in coil blocks 100, 200 include non-magnetic, non-metallic materials capable of withstanding the temperatures encountered within coil windings of an electrical machine. Such materials include, but are not limited to: textolite, fluoroplastics, nylons, glass-epoxy plastics, glass-fiber plastics, laminated bakelite insulation (paper-based laminate). In some embodiments of the invention, coil blocks 100, 200 are bonded together to form coil block assembly 900. Such bonding may include melting and joining coil blocks 100, 200, applying an adhesive therebetween, or any other known or later-developed bonding method or technique. The method or technique employed will depend, at least in part, on the materials from which coil blocks 100, 200 are composed.

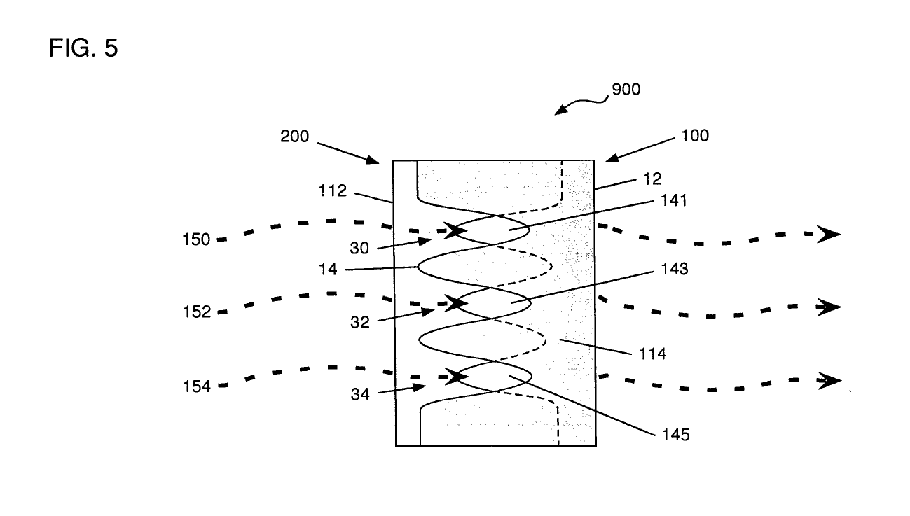

FIG. 5 shows a side view of coil block assembly 900 to illustrate how a size and/or shape of cooling channels 141, 143, 145 may be varied by offsetting coil block 100 with respect to coil block 200. Here, coil blocks 100, 200 are offset such that a portion of second faces 12, 112 are positioned beyond first face 14, 114 of the opposing coil block, thereby increasing the sizes of cooling channels 141, 143, 145, as compared to FIG. 2. Offsetting coil blocks 100, 200 in the opposite direction, such that second faces 12, 112 are positioned laterally within a space between first faces 14, 114 will decrease the sizes of cooling channels 141, 143, 145, as compared to FIG. 2.

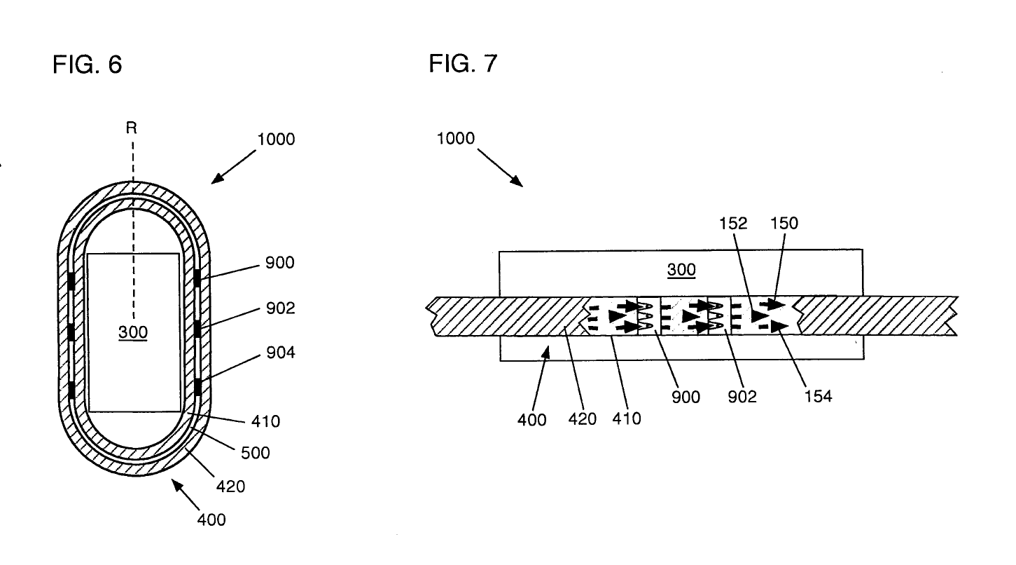

FIG. 6 shows a schematic top cross-sectional view of a tooth coil 1000 comprising a stator tooth 300 surrounded by coil turns 400. As shown in FIG. 6, stator tooth 300 is rectangular in cross-section, although this is not essential. Coil turns 400 include an inner turn 410 and an outer turn 420 stacked substantially parallel to a radial axis R of stator tooth 300. As will be understood by one skilled in the art, inner turn 410 and outer turn 420 will be connected in series or in parallel. For the sake of simplicity, this is not shown in FIG. 6.

A plurality of coil block assemblies 900, 902, 904 are positioned between inner turn 410 and outer turn 420, forming a space 500 therebetween. FIG. 7 shows a side cross-sectional view of tooth coil 1000, along line A of FIG. 6, with a portion of outer turn 420 partially cut away for purposes of description. Airflow 150, 152, 154 circulates through space 500 (FIG. 6) and through cooling channels 140, 142, 144 (FIG. 2) of coil block assemblies 900, 902.

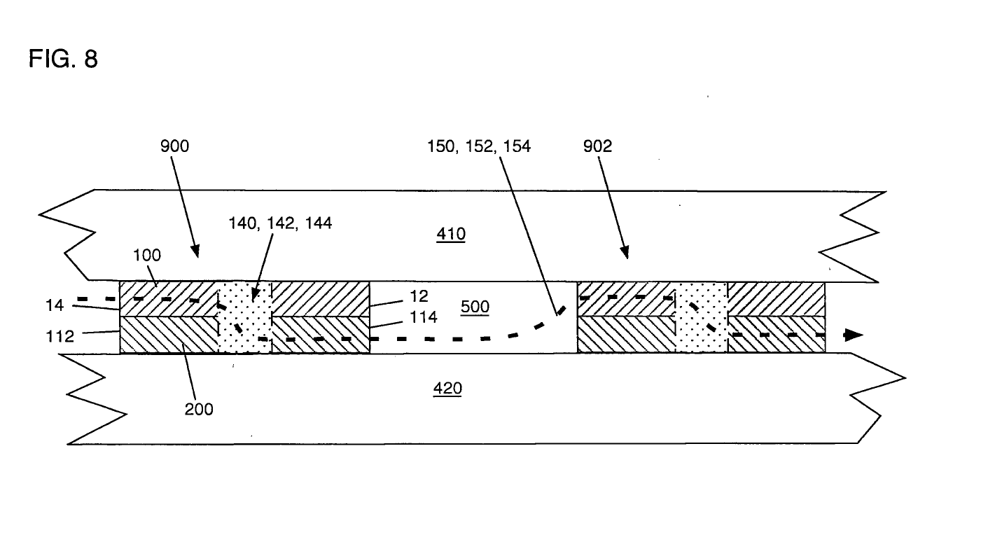

FIG. 8 shows a partial top cross-sectional view of airflow 150, 152, 154 though coil block assemblies 900, 902. As can be seen, airflow 150, 152, 154 circulating through space 500 encounters coil block assembly 900 and passes into recesses (30, 32, 34 in FIG. 2), through cooling channels 140, 142, 144, and exits through recesses of coil block 200. Airflow 150/152/154 then continues through space 500 until encountering coil block 902, through which it passes analogously to coil block 900.

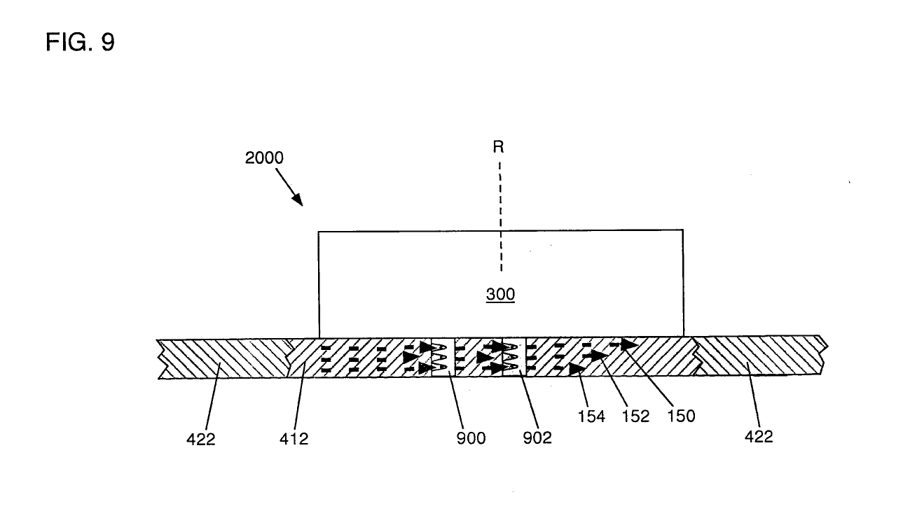

Coil block assemblies according to embodiments of the invention may be used in other configurations. For example, FIG. 9 shows a partial top cross-sectional view of a portion of a tooth coil 2000 according to another embodiment of the invention. Here, coil turns 412, 422 are stacked axially, i.e., substantially perpendicular to a radial axis R of stator tooth 300. That is, as shown in FIG. 9, coil turns 412, 422 are stacked into and out of the page. For purposes of illustration, upper coil turn 422 is shown partially cut away.

Similar to the embodiment shown in FIGS. 6 and 7, the positioning of coil block assemblies 900, 902 between lower coil turn 412 and upper coil turn 422 in FIG. 9 forms a void (not shown in FIG. 9) therebetween. Airflow 150, 152, 154 circulates through the void and coil block assemblies 900, 902, similar to the pattern shown in FIG. 8.

While the coil block assemblies 900, 902, 904 in the preceding figures have been shown as comprising a pair of coil blocks 100, 200, each having substantially the same shape and structure, this is not essential. It may be desirable, for example, to employ a coil block assembly having a non-rectangular cross-sectional shape and/or a coil block assembly comprising coil blocks having different shapes and/or structures.

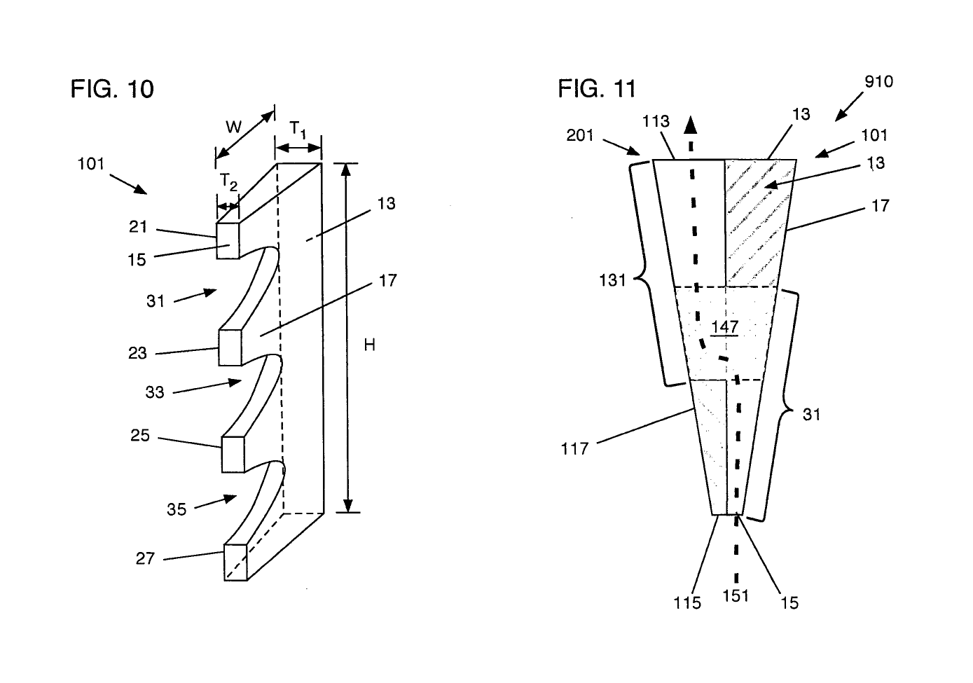

For example, FIG. 10 shows a perspective view of a coil block 101 according to another embodiment of the invention. Here, the thickness of coil block 101 varies along its width W from a first thickness T₁ at first face 15 to a second thickness T₂ at second face 13 (shown in phantom), first thickness T₁ being greater than second thickness T₂.

FIG. 11 shows a cross-sectional top view of a coil block assembly 910 comprising a pair of opposed coil blocks 101, 201. Coil block 101 is shown as in FIG. 10. Coil block 201 has a thickness greater at second face 113 than at first face 115. When placed together as shown in FIG. 11, coil blocks 101, 201 give coil block assembly 910 a trapezoidal shape in cross-section. As in other embodiments of the invention described above, recesses 31, 131 in coil blocks 101, 201 form a cooling channel 147. Airflow 151 enters cooling block assembly 910 through recess 31 of coil block 101, passes into cooling channel 147, and exist coil block assembly 910 through recess 131 of coil block 201.

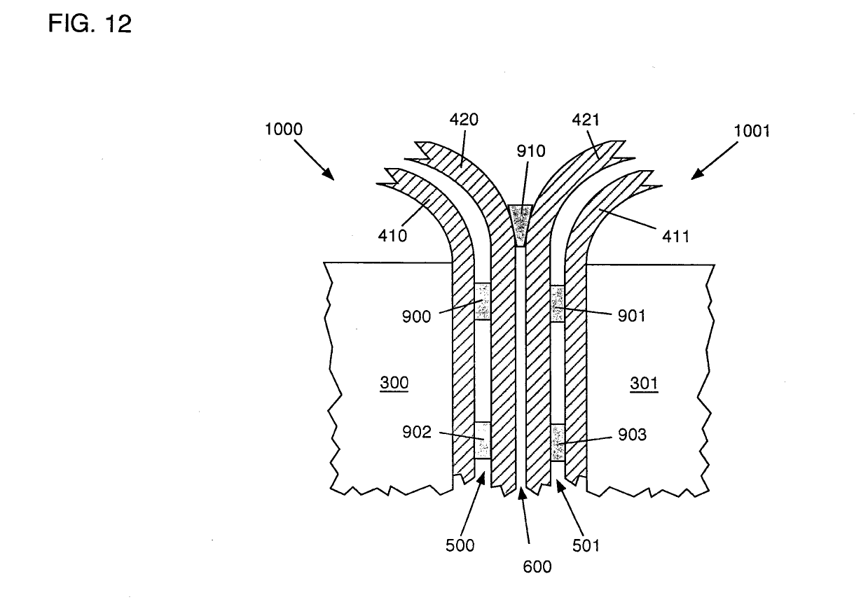

FIG. 12 shows a partial cross-sectional top view of adjacent tooth coils 1000, 1001 in an electrical machine in which a coil block assembly 910 such as that in FIG. 11 may be employed. Outer turns 420, 421 define a slot 600 between adjacent tooth coils 1000, 1001. While substantially rectangular coil block assemblies such as those shown in FIGS. 2-5 may be used within portions of slot 600 in which outer turns 420, 421 are substantially parallel, their utility in other locations is reduced. In FIG. 12, a coil block assembly 910 having a substantially trapezoidal shape in cross-section is located between portions of outer turns 420, 421 that are not parallel. As such, airflow (not shown) through slot 600 passes through coil block assembly 910 before exiting slot 600.

Situations and locations in which coil block assemblies having other shapes may be useful will be apparent to those skilled in the art and are within the scope of the invention. Similarly, the coil blocks and coil block assemblies shown above, and the contexts in which they are employed, are merely illustrative and provided for purposes of illustration and should not be considered as limiting the scope of the invention.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrical machine comprising:
at least one tooth coil including:
a stator tooth; and
at least one conductive coil wound around the stator tooth, forming a plurality of coil turns;
a coil block assembly between a first turn and a second turn of the plurality of coil turns, the coil block assembly including:
at least two coil blocks, each coil block including a body and a face having at least one recess into the body, wherein the coil blocks are oriented with faces opposed, such that at least one cooling channel is formed by the at least one recess of each coil block.

2. The electrical machine of claim 1, wherein each of the at least two coil blocks includes a face having a plurality of recesses into the body and the coil block assembly includes a plurality of cooling channels formed by the plurality of recesses.

3. The electrical machine of claim 1, wherein the plurality of recesses form a substantially sinusoidal shape along the face.

4. The electrical machine of claim 1, wherein the body of each of the at least two coil blocks includes a height, a width substantially perpendicular to the height, and at least one thickness substantially perpendicular to both the height and the width.

5. The electrical machine of claim 4, wherein the at least one thickness is less than the width.

6. The electrical machine of claim 4, wherein the body of each of the at least two coil blocks has a substantially rectangular cross-sectional shape.

7. The electrical machine of claim 4, wherein the at least one recess extends into the body in a direction substantially parallel to the width.

8. The electrical machine of claim 1, wherein each of the at least two coil blocks consists essentially of at least one non-magnetic, non-metallic material.

9. The electrical machine of claim 8, wherein the non-magnetic, non-metallic material is selected from a group consisting of: textolite, a fluoroplastic, a nylon, a glass-epoxy plastic, a glass-fiber plastic, and a laminated bakelite insulation.

10. The electrical machine of claim 8, wherein the at least two coil blocks are bonded together.

11. The electrical machine of claim 1, wherein the first turn and the second turn are stacked substantially parallel to a radial axis of the stator tooth.

12. The electrical machine of claim 1, wherein the first turn and the second turn are stacked substantially perpendicular to a radial axis of the stator tooth.

13. An electrical machine comprising:
a plurality of tooth coils, each tooth coil including:
a stator tooth; and
at least one conductive coil wound around the stator tooth, forming a plurality of coil turns; and
a coil block assembly between an outer turn of the plurality of coil turns of a first tooth coil and an outer turn of the plurality of coil turns of a second tooth coil, the coil block assembly including a plurality of coil blocks, at least two coil blocks each including:
a body; and
a first face having at least one recess into the body,
wherein the at least two coil blocks are oriented with first faces opposed to form at least one cooling channel including the at least one recess of each of at least two coil blocks.

14. The electrical machine of claim 13, wherein the body of each of the at least two coil blocks includes a first thickness at a proximal end of the body and a second thickness less than the first thickness at a distal end of the body.

15. The electrical machine of claim 14, wherein the coil block assembly has a substantially trapezoidal shape in cross-section.

16. The electrical machine of claim 13, wherein each of the at least two coil blocks consists essentially of at least one non-magnetic, non-metallic material.

17. The electrical machine of claim 16, wherein the non-magnetic, non-metallic material is selected from a group consisting of: textolite, a fluoroplastic, a nylon, a glass-epoxy plastic, a glass-fiber plastic, and a laminated bakelite insulation.

18. A coil block comprising:
a body including a proximal end having a first thickness and a distal end having a second thickness less than the first thickness;
a first face having at least one recess into the body;
a first surface substantially perpendicular to the first face; and
a second surface angled with respect to the first surface and the first face,
whereby a pair of coil blocks oriented with first faces thereof opposed has a substantially trapezoidal shape in cross-section and form at least one cooling channel comprised of the at least one recess of each of the pair of coil blocks.

19. The coil block of claim 18, consisting essentially of at least one non-magnetic, non-metallic material selected from a group consisting of: textolite, a fluoroplastic, a nylon, a glass-epoxy plastic, a glass-fiber plastic, and a laminated bakelite insulation.

20. The coil block of claim 18, wherein the at least one recess extends into the body in a direction substantially parallel to the first surface.
